(19) United States
(12) Patent Application Publication
(10) Pub. No.: US 2012/0139867 A1
(43) Pub. Date: Jun. 7, 2012

(54) CAPACITIVE TOUCH APPARATUS

(76) Inventors: Sean CHANG, Taoyuan Hsien (TW); Chii-How CHANG, Taoyuan Hsien (TW); Chin-Wei KUO, Taoyuan Hsien (TW)

(21) Appl. No.: 13/293,467

(22) Filed: Nov. 10, 2011

(30) Foreign Application Priority Data
Dec. 1, 2010 (TW) 099141663

(51) Int. Cl. G06F 3/044

(52) U.S. Cl. 345/174

(57) ABSTRACT

A capacitive touch apparatus includes a first touch unit, a first voltage difference retrieving unit, a first feedback signal generating unit, and a control unit. The first touch unit has a touch substrate and a first conductive layer. The first voltage difference retrieving unit is electrically connected with the first conductive layer and outputs a first voltage signal and a second voltage signal. The first feedback signal generating unit outputs a first feedback signal according to the variation of the voltage difference between the first voltage signal and the second voltage signal. The control unit receives the first feedback signal for computing the touch position and outputs a power signal to the first voltage difference retrieving unit. Hence, the capacitive touch apparatus improves the sensing speed and reduces the manufacturing cost by the simple circuit design.

### CROSS REFERENCE TO RELATED APPLICATIONS

This Non-provisional application claims priority under 35 U.S.C. §119(a) on Patent Application No(s). 099141663 filed in Taiwan, Republic of China on Dec. 1, 2010, the entire contents of which are hereby incorporated by reference.

### BACKGROUND OF THE INVENTION

1. Field of Invention

The present invention relates to a touch apparatus and, in particular, to a capacitive touch apparatus.

2. Related Art

The touch panels are easily operated, so they are applied to various kinds of electronic products, such as mobile communication, consumer electronic devices, to replace the traditional buttons. In these electronic products, the display panel and the touch panel, which is used as the input device, are combined, so that the electronic products become more valuable.

FIG. 1 is a schematic diagram showing a conventional capacitive touch apparatus 1, which senses the touch operation by charge transfer. The capacitive touch apparatus 1 includes two reset switches 11 and 12, two capacitors Cₚ and Cₛᵤₘ, and a comparator 13. Herein, the capacitor Cₚ is the capacitor of the sensing electrode. The capacitor Cₚ is electrically connected with the power signal V_{DD} through the reset switch 11. The capacitor Cₛᵤₘ is connected with the reset switch 12 in parallel, and one end of the capacitor Cₛᵤₘ and one end of the reset switch 12 are connected to one input of the comparator 13. The capacitive touch apparatus 1 also provides a reference voltage Vₜₕ to the other input of the comparator 13, so that the comparator 13 can compare the inputted voltages and then output a voltage Vₒᵤₜ.

Since the capacitor Cₚ is electrically connected to the power signal V_{DD} through the reset switch 11, the power signal V_{DD} can charge the capacitor Cₚ and then the reset switch 11 is switched to discharge the capacitor Cₚ for charging the capacitor Cₛᵤₘ. Accordingly, the electricity of the capacitor Cₚ can be transferred to the capacitor Cₛᵤₘ. During the operation of the capacitive touch apparatus 1, the above-mentioned charging and discharging procedures of the capacitor Cₚ are repeatedly performed. When a finger touches the touch panel, the voltage of the capacitor Cₚ is increased. Then, when the reset switch 11 is switched, the voltage of the capacitor Cₛᵤₘ is accordingly increased. The ranges of the above increases of the voltage are determined according to the ratio of the capacities of the capacitor Cₚ and the capacitor Cₛᵤₘ. In this case, the variation of the capacitor Cₚ can be obtained by measuring the time period that the voltages exceed a constant voltage. After the measurement, the reset switch 12 is switched to discharge the capacitor Cₛᵤₘ so as to allow the capacitor Cₛᵤₘ to return its initial state. Following the above-mentioned steps, the touch operation can be detected.

However, because the capacitive touch apparatus 1 needs the charging and discharging procedures of two capacitors for detecting the touch operation, it spends more time in the detecting so that the response time of the capacitive touch apparatus 1 is slower. In addition, the conventional capacitive touch apparatus usually uses the detecting circuit with single end sensing wire, so it can not obtain the absolute coordinates of the touch position. Therefore, it is an important subject to provide a capacitive touch apparatus that can improve the sensing speed and is capable of obtaining the absolute coordinates of the touch position by the simple circuit design.

### SUMMARY OF THE INVENTION

In view of the foregoing subject, an object of the present invention is to provide a capacitive touch apparatus that can improve the sensing speed by the simple circuit design.

To achieve the above object, the present invention discloses a capacitive touch apparatus including a first touch unit, a first voltage difference retrieving unit and a first feedback signal generating unit. The first touch unit includes a first conductive layer. The first voltage difference retrieving unit is electrically connected with one end of the first conductive layer and outputs a first voltage signal and a second voltage signal. The first feedback signal generating unit is electrically connected with the first voltage difference retrieving unit, and outputs a first feedback signal according to the variation of the voltage difference between the first voltage signal and the second voltage signal for computing a touch position.

In one embodiment of the present invention, the capacitive touch apparatus further includes a control unit electrically connected with the first voltage difference retrieving unit and the first feedback signal generating unit, wherein the control unit receives the first feedback signal for computing the touch position and outputs a power signal to the first voltage difference retrieving unit.

In one embodiment of the present invention, the first touch unit further includes a second conductive layer disposed above or below the first conductive layer.

In one embodiment of the present invention, the first and second conductive layers respectively comprise a plurality of sensing conductive bars.

In one embodiment of the present invention, each of the sensing conductive bars comprises a plurality of sensing electrodes connected in series, and the sensing electrode of each of the sensing conductive bars is rhombic, square, circular or irregular.

In one embodiment of the present invention, the sensing conductive bars of the first and second conductive layers are extended in perpendicular and not electrically connected with each other, and one end of the sensing conductive bars of the first and second conductive layers are electrically connected with the first voltage difference retrieving unit.

In one embodiment of the present invention, the first voltage difference retrieving unit comprises a first voltage-drop device, a first retrieving device and a second retrieving device, the first voltage-drop device is connected with the first touch unit, a power signal is provided through the first voltage-drop device to the first touch unit, and the first retrieving device connects to one end of the first voltage-drop device and outputs the first voltage signal, and the second retrieving device connects to the other end of the first voltage-drop device and outputs the second voltage signal.

In one embodiment of the present invention, each of the first retrieving device and the second retrieving device is a voltage follower.

In one embodiment of the present invention, the first feedback signal generating unit comprises an operation device for receiving the first voltage signal and the second voltage signal, and the operation device is a differential amplifier.

In one embodiment of the present invention, the power signal is a sine-wave power signal.

In one embodiment of the present invention, the control unit includes a microcontroller and a waveform modulator, the microprocessor outputs a square-wave voltage signal to the waveform modulator, and the waveform modulator outputs the sine-wave power signal.

In one embodiment of the present invention, the capacitive touch apparatus further includes a first selection unit electrically connected with the first touch unit and the first voltage difference retrieving unit.

In one embodiment of the present invention, the first selection unit includes at least one multiplexer and a plurality of resistors, one end of the multiplexer and one end of each of the resistors are electrically connected with the first touch unit, and the other end of the multiplexer is electrically connected with the first voltage difference retrieving unit.

In one embodiment of the present invention, the resistance value of the resistor of the first selection unit is much greater than that of the first voltage-drop device.

In one embodiment of the present invention, the capacitive touch apparatus further includes a second voltage difference retrieving unit and a second feedback signal generating unit. The second voltage difference retrieving unit is electrically connected with the other end of the first conductive layer and includes a second voltage-drop device, a third retrieving device and a fourth retrieving device, wherein the third retrieving device connects to one end of the second voltage-drop device and outputs a third voltage signal, and the fourth retrieving device connects to the other end of the second voltage-drop device and outputs a fourth voltage signal. The second feedback signal generating unit includes an operation device and receives the third voltage signal and the fourth voltage signal, and outputs a second feedback signal to the control unit according to the voltage difference between the third voltage signal and the fourth voltage signal.

In one embodiment of the present invention, the capacitive touch apparatus further includes a second touch unit electrically connected with the first touch unit.

In one embodiment of the present invention, one end of the second touch unit, which is not connected with the first touch unit, is electrically connected with the first voltage difference retrieving unit.

In one embodiment of the present invention, the capacitive touch apparatus further includes a third touch unit electrically connected with the first touch unit, and one end of the third touch unit is electrically connected with the second voltage difference retrieving unit.

As mentioned above, the capacitive touch apparatus of the present invention is configured with a first selection unit with a multiplexer for switching the connections between the first voltage difference retrieving unit and a plurality of sensing conductive bars of the first touch unit. In addition, the first voltage difference retrieving unit includes a first retrieving device and a second retrieving device for respectively retrieving the voltages of two ends of the voltage-drop device so as to determine the touch position and touch time. Furthermore, the capacitive touch apparatus of the present invention further includes a second touch unit, which is electrically connected with the first touch unit, without increasing complex connections and detecting the touch position. Accordingly, the capacitive touch apparatus of the present invention can improve the sensing speed and reduce the manufacturing cost by the simple circuit design.

### BRIEF DESCRIPTION OF THE DRAWINGS

The present invention will become more fully understood from the subsequent detailed description and accompanying drawings, which are given by way of illustration only, and thus are not limitative of the present invention, and wherein:

FIG. 1 is a schematic diagram showing a conventional capacitive touch apparatus;

FIG. 2 is a schematic diagram showing a capacitive touch apparatus according to a preferred embodiment of the present invention;

FIG. 3 is a waveform graph for the capacitive touch apparatus according to the preferred embodiment of the present invention;

FIG. 4 to FIG. 6 are schematic diagrams showing various aspects of the first selection unit of the present invention;

FIGS. 7, 8, 9A-9I, and 10A-10E are schematic diagrams showing various aspects of the first touch unit of the present invention; and

FIG. 11 to FIG. 15 are schematic diagrams showing various aspects of the capacitive touch apparatus of the present invention.

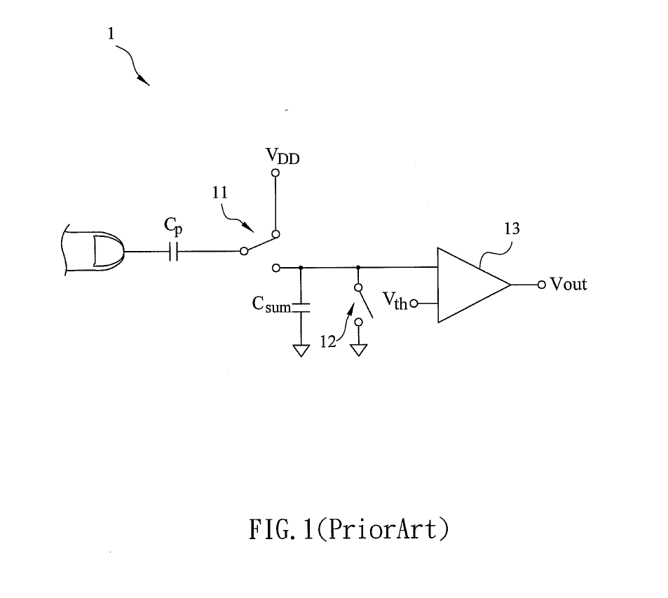

### DETAILED DESCRIPTION OF THE INVENTION

The present invention will be apparent from the following detailed description, which proceeds with reference to the accompanying drawings, wherein the same references relate to the same elements.

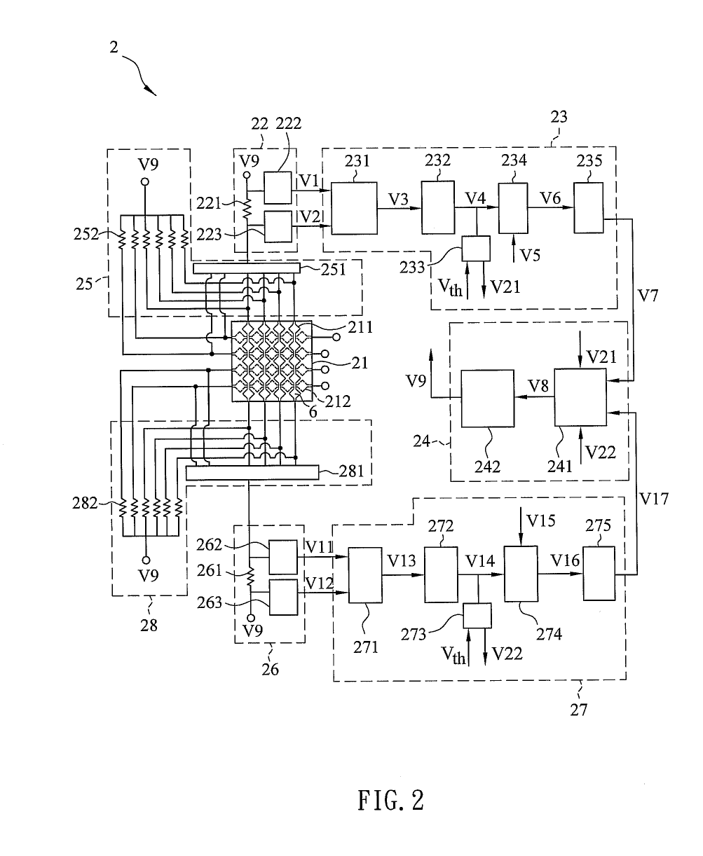

FIG. 2 is a schematic diagram showing a capacitive touch apparatus 2 according to a preferred embodiment of the present invention. The capacitive touch apparatus 2 includes a first touch unit 21, a first voltage difference retrieving unit 22, a first feedback signal generating unit 23, a control unit 24 and a first selection unit 25.

The first touch unit 21 includes a touch substrate (not shown) and a first conductive layer 211. The touch substrate can be a substrate of a touch panel, which is made of glass or plastic. The first conductive layer 211 is shown as the solid lines in the figure and includes a plurality of sensing conductive bars. Each of the sensing conductive bars is formed by connecting a plurality of sensing electrodes 6 in series. The sensing electrode 6 of the sensing conductive bar can be rhombic, square, circular, elliptic, polygonal or irregular. In this embodiment, the sensing electrode 6 is, for example but not limited to, rhombic.

The first touch unit 21 further includes a second conductive layer 212, which also includes a plurality of sensing conductive bars. The sensing conductive bars of the second conductive layer 212 and the sensing conductive bars of the first conductive layer 211 are extended in perpendicular to each other. One end of the second conductive layer 212 is electrically connected with the first voltage difference retrieving unit 22. The sensing electrodes of the sensing conductive bars of the second conductive layer 212 can be rhombic, square, circular, elliptic, polygonal or irregular. In this embodiment, the sensing electrode is, for example but not limited to, rhombic.

The first touch unit 21 further includes an insulation layer (not shown), which is disposed between the first conductive layer 211 and the second conductive layer 212 for preventing the electrical connection between the first conductive layer 211 and the second conductive layer 212.

The first voltage difference retrieving unit 22 is electrically connected with one end of the first conductive layer 211, and it includes a voltage-drop device 221, a first retrieving device 222 and a second retrieving device 223. The voltage-drop device 221 can be a capacitor or a resistor. In this embodiment, the voltage-drop device 221 is, for example but not limited to, a resistor. The first retrieving device 222 connects to one end of the voltage-drop device 221, and the connecting node thereof outputs a first voltage signal V1. The second retrieving device 223 connects to the other end of the voltage-drop device 221, and the connecting node thereof outputs a second voltage signal V2. In this embodiment, each of the first retrieving device 222 and the second retrieving device 223 is a voltage follower for example.

The first feedback signal generating unit 23 is electrically connected with the first voltage difference retrieving unit 22. In detailed, the first feedback signal generating unit 23 includes an operation device 231 for receiving the first voltage signal V1 and the second voltage signal V2, and then the first feedback signal generating unit 23 outputs a voltage difference signal V3 according to the voltage difference between the first voltage signal V1 and the second voltage signal V2. In this embodiment, the operation device 231 is a differential amplifier for example. In addition, the first feedback signal generating unit 23 further includes a filter 232, a comparator 233, a subtractor 234, and an amplifier circuit 235. The filter 232 receives the voltage difference signal V3 and outputs a voltage signal V4 to the subtractor 234. The output of the filter 232 is electrically connected with the comparator 233. A reference voltage Vₜₕ is inputted to the comparator 233, and the comparator 233 outputs a signal V21 to the control unit 24. The subtractor 234 outputs a voltage signal V6 by subtracting a voltage signal V5 from the voltage signal V4. Herein, the voltage signal V5 is provided by an external circuit or a microprocessor 241 of the control unit 24. Finally, the voltage signal V6 is processed by the amplifier circuit 235 to generate a first feedback signal V7. In this embodiment, the filter 232 is a band-pass filter for example. In addition, it is possible to add or remove the amplifier circuit 235 based on different circuit designs. In the capacitive touch apparatus 2 of this embodiment, the first feedback signal generating unit 23 includes the amplifier circuit 235 for example.

The control unit 24 is electrically connected with the first voltage difference retrieving unit 22 and the first feedback signal generating unit 23. The control unit 24 includes a microprocessor 241 and a waveform modulator 242. The microprocessor 241 receives the first feedback signal V7 and converts the analog first feedback signal V7 into a digital signal, thereby outputting a voltage signal V8. Accordingly, the voltage signal V8 is a square-wave voltage signal. The waveform modulator 242 receives the voltage signal V8 and converts it into a sine-wave power signal V9. Finally, the power signal V9 is outputted to the first voltage difference retrieving unit 22 and the first selection unit 25, so that the first voltage difference retrieving unit 22 and the first selection unit 25 can be powered on and enabled.

The first selection unit 25 is electrically connected with the first touch unit 21 and the first voltage difference retrieving unit 22. In this embodiment, the first selection unit 25 includes at least one multiplexer, at least one resistor, and at least one switch device. As shown in FIG. 2, the first selection unit 25 of the capacitive touch apparatus 2 of the embodiment includes a multiplexer 251 and a plurality of resistors 252. One end of the multiplexer 251 and one end of each of the resistors 252 are electrically connected with the first touch unit 21, and the other end of the multiplexer 251 is electrically connected with the first voltage difference retrieving unit 22. In addition, the resistance value of the resistors 252 of the first selection unit 25 is greater than that of the voltage-drop device 221.

Moreover, the capacitive touch apparatus 2 of the present embodiment further includes a second voltage difference retrieving unit 26, a second feedback signal generating unit 27, and a second selection unit 28.

The second voltage difference retrieving unit 26 is electrically connected with one end of the first conductive layer 211 opposite to the first voltage difference retrieving unit 22. Similarly, the second voltage difference retrieving unit 26 includes a voltage-drop device 261, a first retrieving device 262 and a second retrieving device 263. The voltage-drop device 261 can be a capacitor or a resistor. In this embodiment, the voltage-drop device 261 is a resistor for example. The first retrieving device 262 connects to one end of the voltage-drop device 261, and the connecting node thereof outputs a first voltage signal V11. The second retrieving device 263 connects to the other end of the voltage-drop device 261, and the connecting node thereof outputs a second voltage signal V12. In this embodiment, each of the first retrieving device 262 and the second retrieving device 263 is a voltage follower for example.

The second feedback signal generating unit 27 is electrically connected with the second voltage difference retrieving unit 26. In detailed, the second feedback signal generating unit 27 includes an operation device 271 for receiving the first voltage signal V11 and the second voltage signal V12, and then the second feedback signal generating unit 27 outputs a voltage difference signal V13 according to the voltage difference between the first voltage signal V11 and the second voltage signal V12. In this embodiment, the operation device 271 is a differential amplifier for example. In addition, the second feedback signal generating unit 27 further includes a filter 272, a comparator 273, a subtractor 274, and an amplifier circuit 275. The filter 272 receives the voltage difference signal V13 and outputs a voltage signal V14 to the subtractor 274. The output of the filter 272 is electrically connected with the comparator 273. A reference voltage Vₜₕ is inputted to the comparator 273, and the comparator 273 outputs a signal V22 to the control unit 24. The subtractor 274 outputs a voltage signal V16 by subtracting a voltage signal V15 from the voltage signal V14. Herein, the voltage signal V15 is provided by an external circuit or a microprocessor 241 of the control unit 24. Finally, the voltage signal V16 is processed by the amplifier circuit 275 to generate a second feedback signal V17. In this embodiment, the filter 272 is a band-pass filter for example. In addition, it is possible to add or remove the amplifier circuit 275 based on different circuit designs. In the capacitive touch apparatus 2 of this embodiment, the second feedback signal generating unit 27 includes the amplifier circuit 275 for example.

The second selection unit 28 is electrically connected with the first touch unit 21 and the second voltage difference retrieving unit 26. In this embodiment, the second selection unit 28 includes at least one multiplexer, at least one resistor, and at least one switch device. As shown in FIG. 2, the second selection unit 28 of the capacitive touch apparatus 2 of the embodiment includes a multiplexer 281 and a plurality of resistors 282. One end of the multiplexer 281 and one end of each of the resistors 282 are electrically connected with the first touch unit 21, and the other end of the multiplexer 281 is electrically connected with the second voltage difference retrieving unit 26. In addition, the resistance value of the resistors 282 of the second selection unit 28 is greater than that of the voltage-drop device 261.

In this embodiment, the second voltage difference retrieving unit 26 is electrically connected with one end of part of the second conductive layer 212, and one end of the other part of the second conductive layer 212 is electrically connected with the first voltage difference retrieving unit 22.

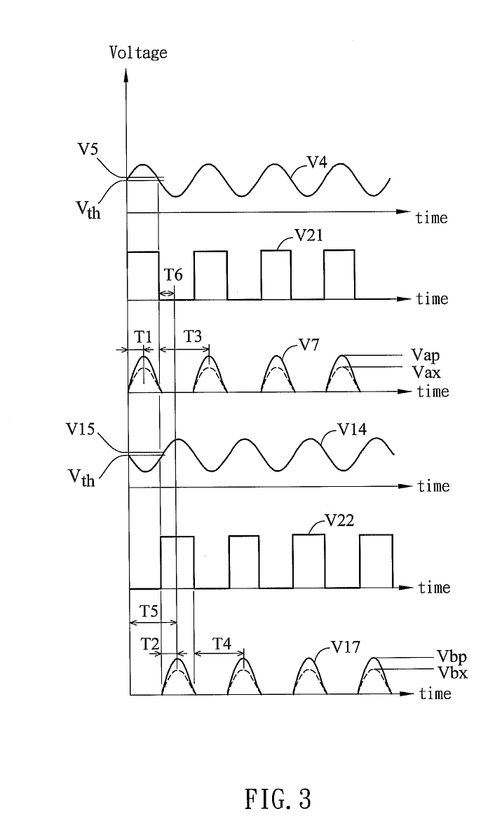

The structure of the capacitive touch apparatus 2 of the present invention is illustrated hereinabove, and the practical application and operation thereof will be described herein below with reference to FIG. 2 in view of FIG. 3. Herein, FIG. 3 is a waveform graph for the capacitive touch apparatus 2.

The control unit 24 provides a power signal V9 to the first voltage difference retrieving unit 22, the first selection unit 25, the second voltage difference retrieving unit 26, and the second selection unit 28. The microprocessor 241 of the control unit 24 controls the switches of the multiplexers 251 and 281 of the first and second selection units 25 and 28, so as to scan the sensing conductive bars of the first and second conductive layers 211 and 212 back and forth. The first selection unit 25 is electrically connected with the first voltage difference retrieving unit 22, and the second selection unit 28 is electrically connected with the second voltage difference retrieving unit 26. The first retrieving devices 222 and 262 retrieves one end of the voltage-drop devices 221 and 261 to output the first voltage signals V1 and V11 to the operation devices 231 and 271. On the contrast, the second retrieving devices 223 and 263 retrieves the other end of the voltage-drop devices 221 and 261 to output the second voltage signals V2 and V12 to the operation devices 231 and 271. Accordingly, the capacitive touch apparatus 2 can determine whether the finger touches the touch substrate or not.

The following description will take the detection of the first conductive layer 211 as an example. After the operation device 231 calculates with the first voltage signal V1 and the second voltage signal V2, it outputs the voltage difference signal V3. Then, the filter 232 filters the signal to generate the voltage signal V4, which is then transmitted to the comparator 233 and the subtractor 234. Before entering into the comparator 233, the waveform of the voltage signal V4 is a sine-wave voltage signal. The comparator 233 compares the voltage signal V4 with a reference voltage Vₜₕ and then outputs a signal V21 to the microprocessor 241. The signal V21 is a square-wave signal. The subtractor 234 can subtract the voltage signal V5 from the voltage signal V4 to obtain the voltage signal V6, which is amplified by the amplifier circuit 235 to obtain the first feedback signal V7. The microprocessor 241 utilizes the rising edge of the signal V21 to trigger a counter to start counting. When counter counts to time T1, the microprocessor 241 starts to read the voltage value of the first feedback signal V7. To be noted, the microprocessor 241 may also utilize the falling edge of the signal V21 to trigger the counter, and, in the case, the counter will count to time T3. After reading the voltage value of the first feedback signal V7, the microprocessor 241 performs the AC/DC conversion. At this moment, the read voltage value is the peak of the first feedback signal V7. When the finger touches the sensing lines, the peak of the first feedback signal V7 is changed (normally it is increased). As shown in FIG. 3, the dotted line represents the first feedback signal V7 as the sensing line is not touched, and the solid line represents the first feedback signal V7 as the sensing line is touched. Consequently, the microprocessor 241 can determine which sensing line is touched by the finger. In practice, if the sensing line is not touched, the read peak is Vax; otherwise, if the sensing line is touched, the read peak is Vap.

After calculating with the first voltage signal V11 and the second voltage signal V12, the operation device 271 outputs the voltage difference signal V13. Then, the filter 272 filters the signal to generate the voltage signal V14, which is then transmitted to the comparator 273 and the subtractor 274. The comparator 273 compares the voltage signal V14 with the reference voltage Vₜₕ and then generates a signal V22, which is a square-wave voltage signal. The subtractor 274 subtracts the voltage signal V15 from the voltage signal V14 to obtain the voltage signal V16, which is amplified by the amplifier circuit 275 to obtain the second feedback signal V17. The microprocessor 241 utilizes the rising edge of the signal V22 to trigger a counter to start counting. When counter counts to time T2, the microprocessor 241 starts to read the voltage value of the second feedback signal V17. To be noted, the microprocessor 241 may also utilize the falling edge of the signal V22 to trigger the counter, and, in the case, the counter will count to time T4. After reading the voltage value of the second feedback signal V17, the microprocessor 241 performs the AC/DC conversion. At this moment, the read voltage value is the peak of the second feedback signal V17. When the finger touches the sensing lines, the peak of the second feedback signal V17 is changed (normally it is increased). As shown in FIG. 3, the dotted line represents the second feedback signal V17 as the sensing line is not touched, and the solid line represents the second feedback signal V17 as the sensing line is touched. In practice, if the sensing line is not touched, the read peak is Vbx; otherwise, if the sensing line is touched, the read peak is Vbp.

It is also possible to directly utilize the rising edge of the signal V21 to trigger the counter to start counting with regardless the comparator 273 and the signal V22. In this case, after the counter counts to time T5, the voltage value of the second feedback signal V17 is read. Then, the microprocessor 241 performs the AC/DC conversion. Alternatively, it is also possible to utilize the falling edge of the signal V21 to trigger the counter to start counting. In this case, after the counter counts to time T6, the voltage value of the second feedback signal V17 is read for performing the AC/DC conversion.

After obtaining the variations Vai and Vbi of the voltage differences between two ends of a single sensing conductive bar of the first conductive layer 211 (Vai=Vap−Vax,Vbi=Vbp−Vbx), and switching all sensing conductive bars of the same direction (e.g. the horizontal direction) by the multiplexers 251 and 281, the variations Vai and Vbi is multiplied by the coordinates Xi of the sensing conductive bars respectively so as to obtain the centroid coordinate X, which represents the X-axle coordinate value of the touch position. The centroid coordinate X can be calculated by the following Equations (1), (2), and (3). Herein, the first conductive layer 211 of the first touch unit 21 has 1^{st} to N^{th} sensing conductive bars, and i is between 1 to N.

$$\begin{matrix}X = {\sum }_{i = 1}^{N} Xi * Vai / {\sum }_{i = 1}^{N} Vai , & Equation ( 1 ) \\ X = {\sum }_{i = 1}^{N} Xi * Vbi / {\sum }_{i = 1}^{N} Vbi , and & Equation ( 2 ) \\ X = {\sum }_{i = 1}^{N} Xi * ( Vai + Vbi ) / {\sum }_{i = 1}^{N} ( Vai + Vbi ) . & Equation ( 3 )\end{matrix}$$

If only the data relate to the first conductive layer 211 is available, the coordinate Y, which represent the Y-axle coordinate value of the touch position, can be obtained according to the following Equation (4).

Y=(Vai−Vbi)/(Vai+Vbi) Equation (4).

After obtaining the variations Vci and Vdi of the voltage differences between two ends of a single sensing conductive bar of the second conductive layer 212, and switching all sensing conductive bars of the same direction (e.g. the vertical direction) by the multiplexers 251 and 281, the variations Vci and Vdi is multiplied by the coordinates Yi of the sensing conductive bars respectively so as to obtain the centroid coordinate Y, which represents the Y-axle coordinate value of the touch position. The centroid coordinate Y can be calculated by the following Equations (5), (6), and (7). Herein, the second conductive layer 212 of the first touch unit 21 has 1^{st} to N^{th} sensing conductive bars, and i is between 1 to N.

$$\begin{matrix}Y = {\sum }_{i = 1}^{N} Yi * Vci / {\sum }_{i = 1}^{N} Vci , & Equation ( 5 ) \\ Y = {\sum }_{i = 1}^{N} Yi * Vdi / {\sum }_{i = 1}^{N} Vdi , and & Equation ( 6 ) \\ Y = {\sum }_{i = 1}^{N} Yi * ( Vci + Vdi ) / {\sum }_{i = 1}^{N} ( Vci + Vdi ) . & Equation ( 7 )\end{matrix}$$

If only the data relate to the second conductive layer 212 is available, the coordinate X, which represent the X-axle coordinate value of the touch position, can be obtained according to the following Equation (8).

X=(Vci−Vdi)/(Vci+Vdi) Equation (8).

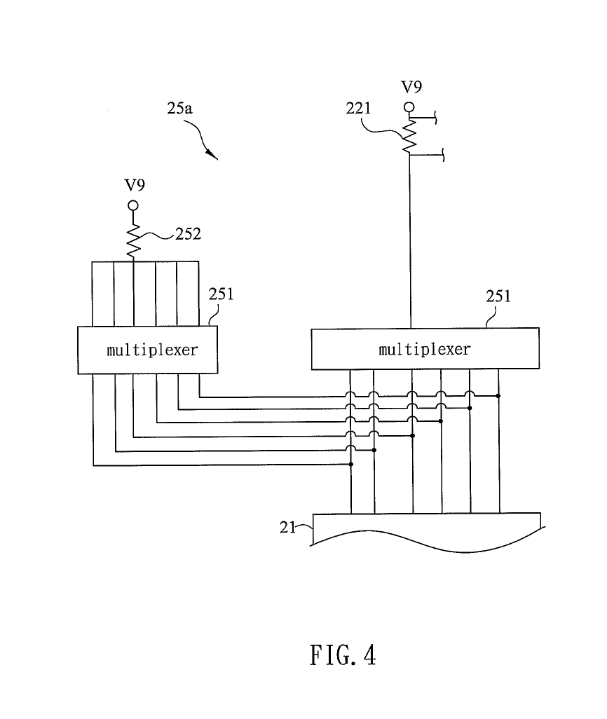

The various aspects of the first selection unit and the second selection unit of the capacitive touch apparatus will be described with reference to FIGS. 4 to 6. In each aspect, the structures of the first and second selection units are the same, so the following description will illustrate the first selection unit only. In addition, for the concise purpose, some elements, such as the first touch unit, the first and second voltage difference retrieving units, and the first and second feedback signal generating units, are omitted in the figures.

Referring to FIG. 4, the first selection unit 25a of this embodiment is different from the first selection unit 25 of the previous embodiment in that the first selection unit 25a includes two multiplexers 251 and one resistor 252. One end of one of the multiplexers 251 is electrically connected with the voltage-drop device 221, and the other end thereof is electrically connected with the first touch unit 21. One end of the other multiplexer 251 is electrically connected with the resistor 252, and the other end thereof is electrically connected with the first touch unit 21. The microprocessor 241 of the control unit 24 controls the switches of the multiplexers 251 so as to scan all sensing conductive bars of the first touch unit 21 back and forth.

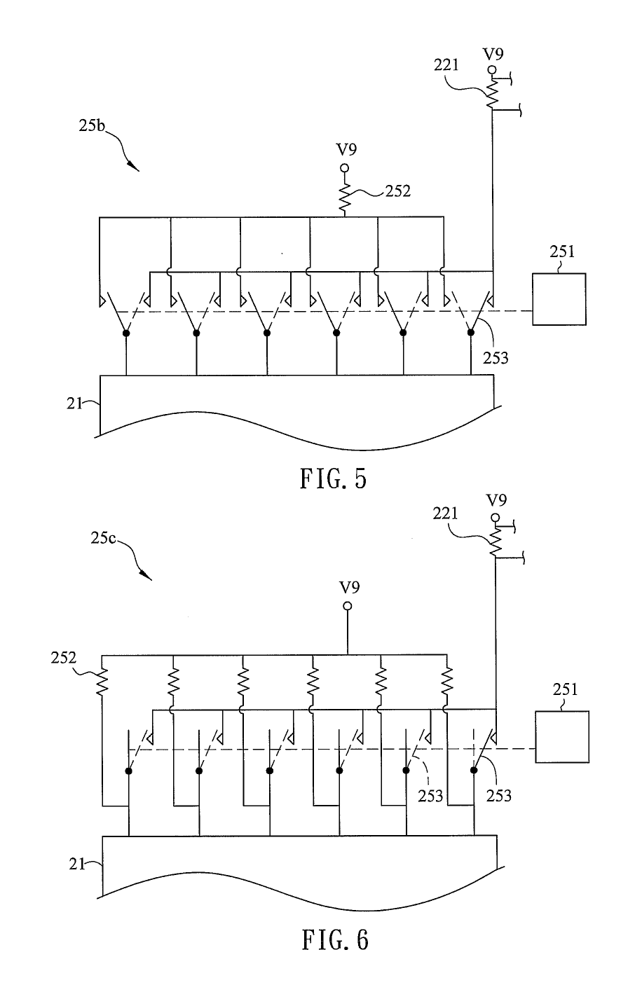

Referring to FIG. 5, the first selection unit 25b of this embodiment is different from the first selection unit 25 of the previous embodiment in that the first selection unit 25b includes one multiplexer 251, one resistor 252, and a plurality of switch device 253. The switch devices 253 are all electrically connected with the multiplexer 251 and the first touch unit 21. The multiplexer 251 controls the switches of the switch devices 253 to connect the voltage-drop device 221 or the resistor 252.

Referring to FIG. 6, the first selection unit 25c of this embodiment is different from the first selection unit 25 of the previous embodiment in that the first selection unit 25c includes one multiplexer 251, a plurality of resistors 252, and a plurality of switch device 253. The switch devices 253 are all electrically connected with the multiplexer 251 and the first touch unit 21. The multiplexer 251 controls the switches of the switch devices 253 to connect the voltage-drop device 221 or the resistors 252.

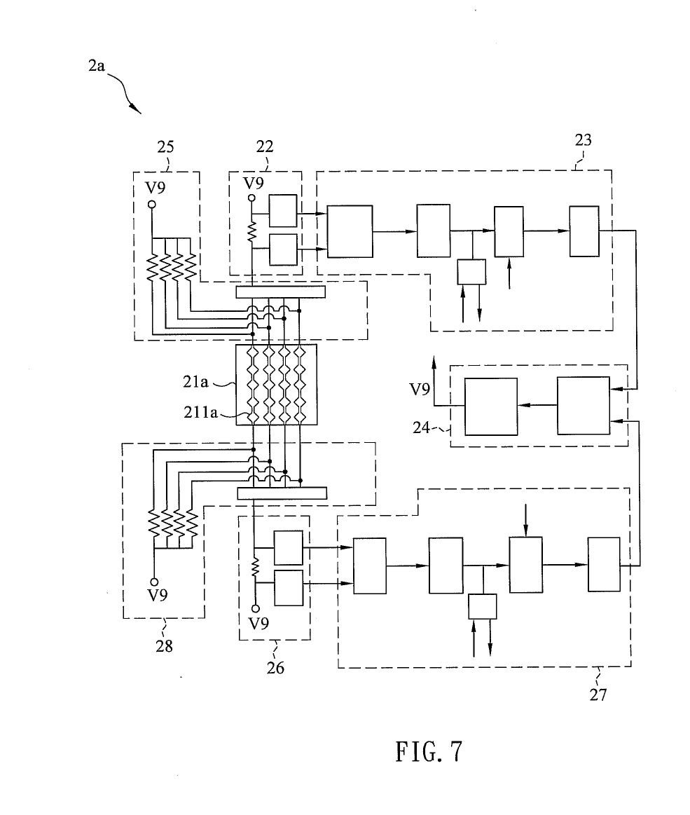

The various aspects of the first touch unit of the capacitive touch apparatus will be described with reference to FIGS. 7 to 10E.

Referring to FIG. 7, the first touch unit 21a of this embodiment is different from the first touch unit 21 of the previous embodiment in that the first touch unit 21a includes only the first conductive layer 211a while the second conductive layer is not configured. The first conductive layer 211a includes a plurality of sensing conductive bars, and the sensing electrode of the sensing conductive bars is rhombic. The sensing conductive bars are electrically connected with the first selection unit 25 and the second selection unit 28.

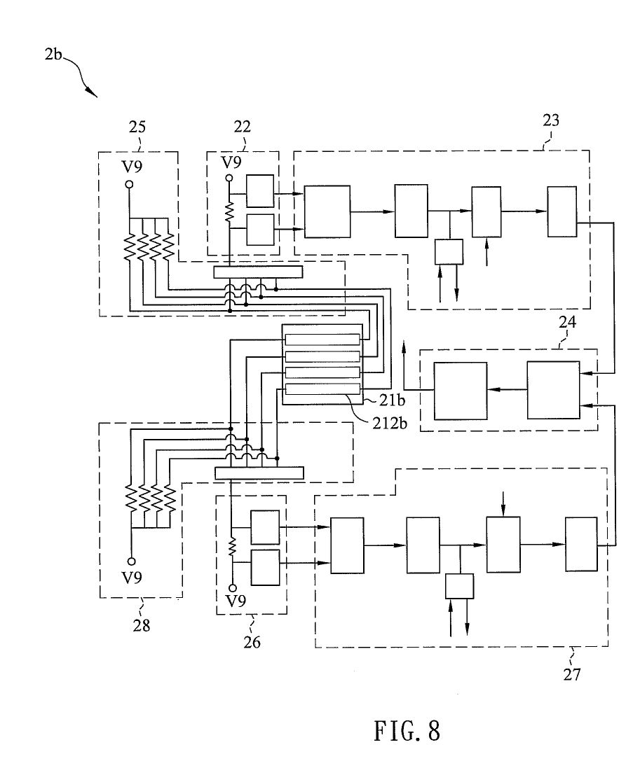

Referring to FIG. 8, the first touch unit 21b of this embodiment is different from the first touch unit 21a of the previous embodiment in that the first touch unit 21b includes only the second conductive layer 212b while the first conductive layer is not configured. The sensing electrode of the sensing conductive bars of the second conductive layer 212b is square. The sensing conductive bars are electrically connected with the first selection unit 25 and the second selection unit 28.

For the concise purpose, some elements, such as the first and second voltage difference retrieving units, the first and second feedback signal generating units, and the first and second selection units, are omitted in the following figures.

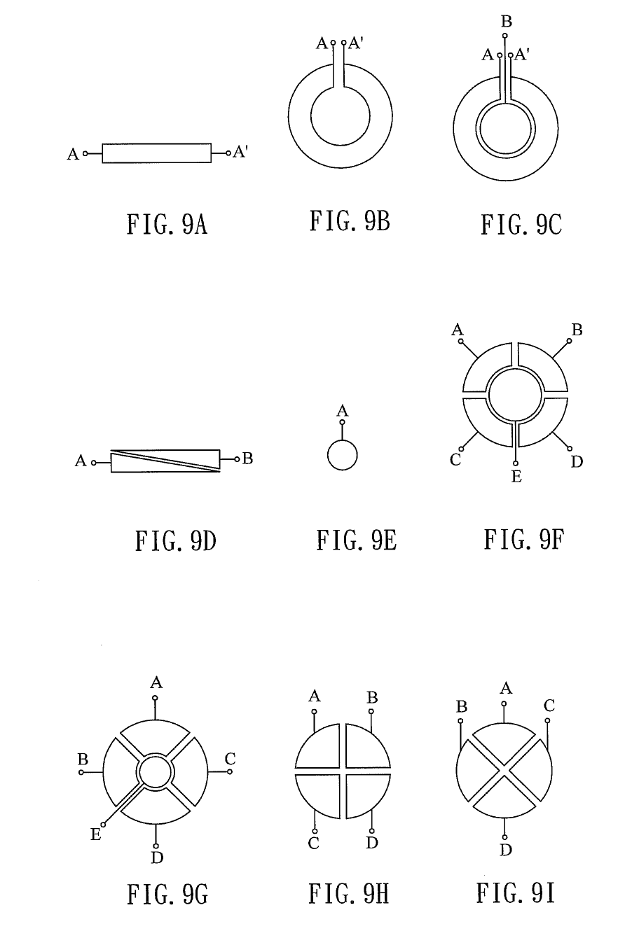

The first touch unit 21 may further connect to a plurality of buttons, bar stick, or arc stick for replacing the sensing conductive bars. As shown in FIGS. 9A to 9I, various aspects of the buttons are disclosed. Herein, the points A and A′ should be connected to two ends of the same sensing conductive bar respectively. Similarly, the pairs of points of different letters, such as “A”, “B”, “C”, “D” and “E”, should be connected to different sensing conductive bars for preventing the interference.

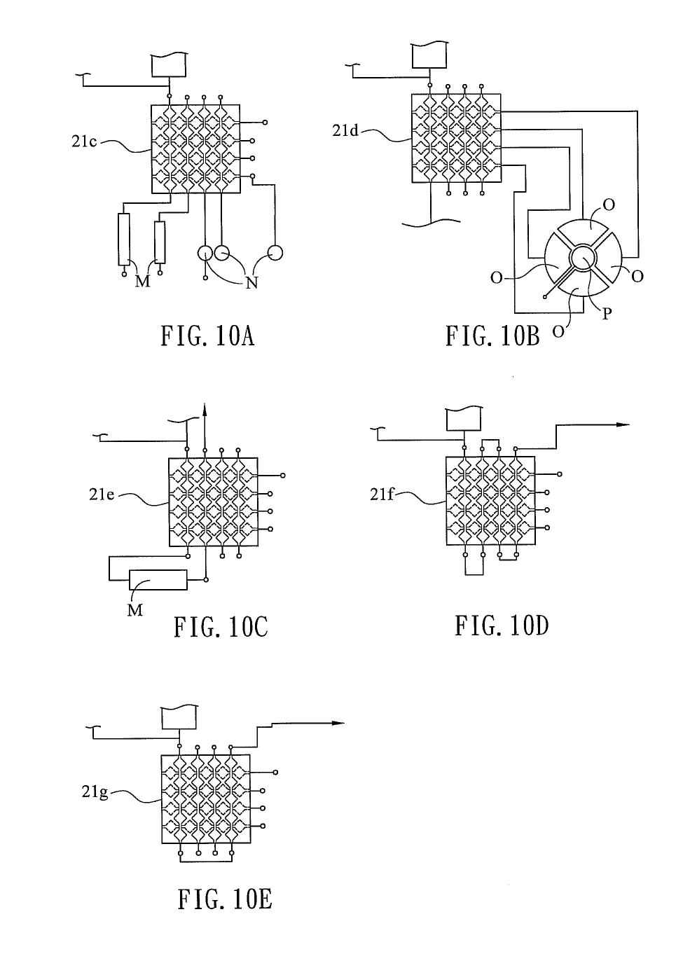

FIGS. 10A to 10E are schematic diagrams showing various aspects of the first touch unit of the present invention. The sensing conductive bars of the first touch units 10A to 10C are electrically connected with at least one button or stick. As shown in FIG. 10A, the sensing conductive bars of the first touch unit 21c are connected with a plurality of sticks M and a plurality of buttons N respectively. As shown in FIG. 10B, a plurality of buttons O are connected with the sensing conductive bars of the first touch unit 21d respectively, and the button P is directly connected with the second selection unit 28 or the sensing conductive bar of the first touch unit 21d. As shown in FIG. 10C, two of the sensing conductive bars of the first touch unit 21e are connected to two ends of the stick M respectively. As shown in FIG. 10D, all sensing conductive bars of the first touch unit 21f are connected in series, while the first sensing conductive bar and latest sensing conductive bar are connected to the first or second selection unit. As shown in FIG. 10E, the first touch units 21g and 21f are different in that part of the sensing conductive bars of the first touch unit 21g, which are separated by several sensing conductive bars, are connected in series. Herein, the interval of the sensing conductive bars connected in series may include any amount of sensing conductive bars.

To be noted, the above aspects of various first touch units are for illustrations only, and the connections or the amount of the connected buttons may different for various aspects of the first touch units.

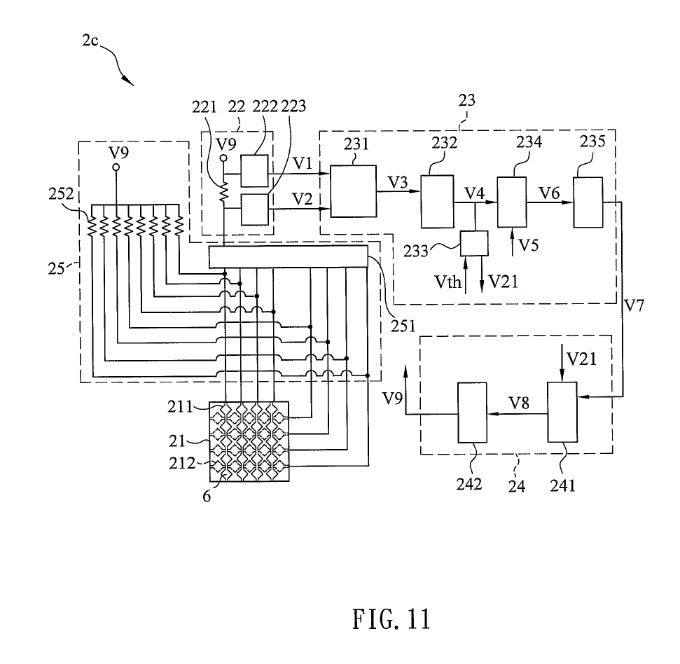

The various aspects of the capacitive touch apparatus will be described with reference to FIGS. 11 to 15. For the concise purpose, some elements, such as the first and second selection units, the first and second voltage difference retrieving units, and the first and second feedback signal generating units, are omitted in the figures.

Referring to FIG. 11, the capacitive touch apparatus 2c of this embodiment is different from the capacitive touch apparatus 2 of the previous embodiment in that the capacitive touch apparatus 2c includes only the first voltage difference retrieving unit 22, the first feedback signal generating unit 23, the control unit and the first selection unit 25. The first selection unit 25 connects to the first conductive layer 211 of the first touch unit 21 and one end of the second conductive layer 212.

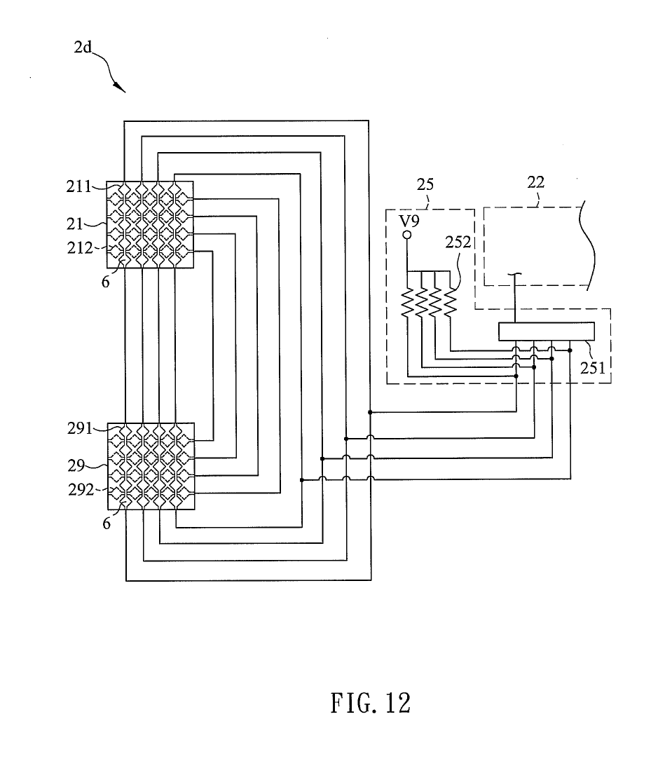

Referring to FIG. 12, the capacitive touch apparatus 2d of this embodiment is different from the capacitive touch apparatus 2c of the previous embodiment in that the capacitive touch apparatus 2d further includes a second touch unit 29. The second touch unit 29 includes a touch substrate (not shown), a first conductive layer 291, and a second conductive layer 292. The technical features of the touch substrate, the first conductive layer 291 and the second conductive layer 292 of the second touch unit 29 are the same as those of the touch substrate, the first conductive layer 211 and the second conductive layer 212 of the first touch unit 21, so the detailed descriptions thereof will be omitted.

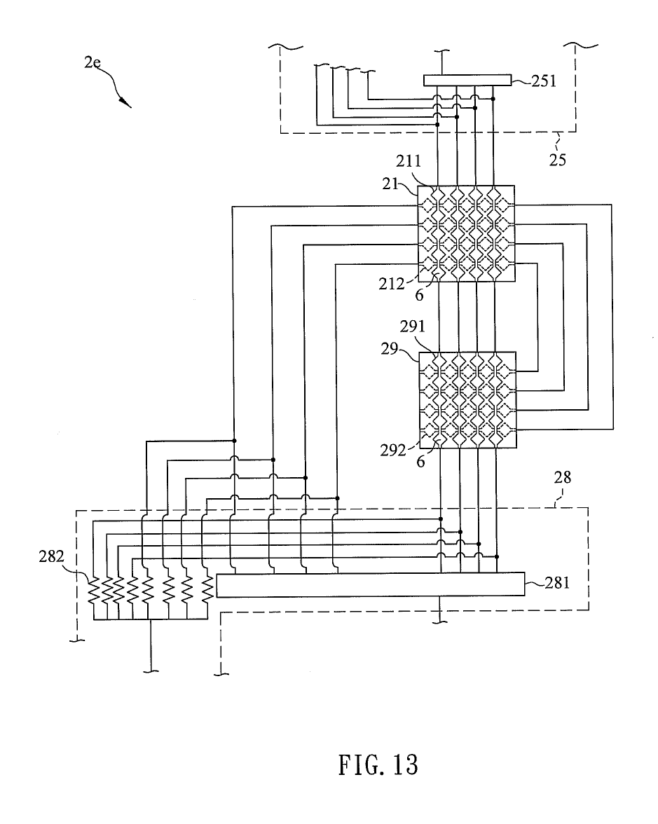

Referring to FIG. 13, the capacitive touch apparatus 2e of this embodiment is different from the capacitive touch apparatus 2d of the previous embodiment in that the capacitive touch apparatus 2e further includes a second voltage difference retrieving unit 26, a second feedback signal generating unit 27, and a second selection unit 28. The second touch unit 29 is electrically connected with the first touch unit 21 in series or in parallel. One end of the first touch unit 21 is electrically connected with the first selection unit 25, and one end of the second touch unit 29 is electrically connected with the second selection unit 28.

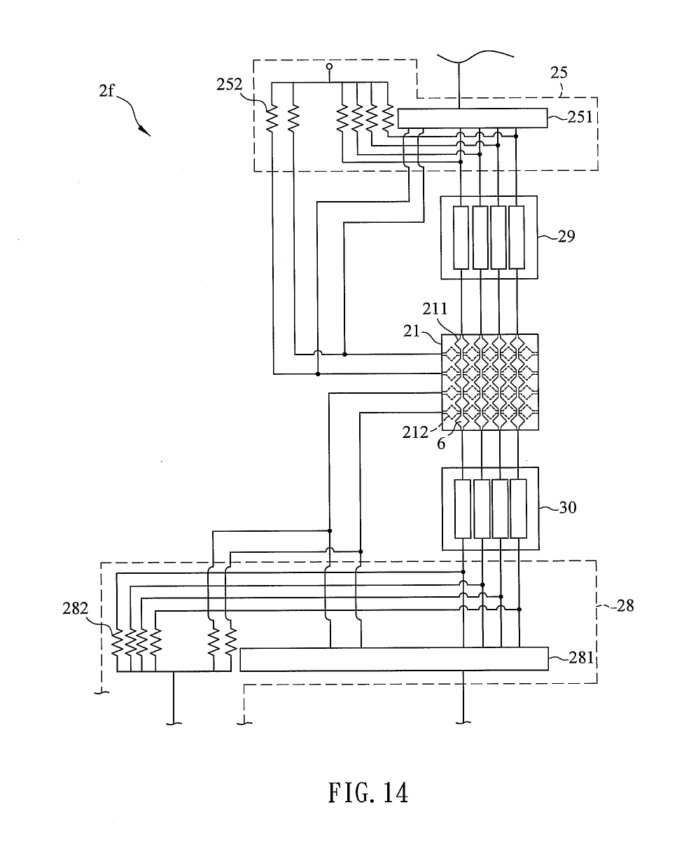

Referring to FIG. 14, the capacitive touch apparatus 2f of this embodiment is different from the capacitive touch apparatus 2e of the previous embodiment in that the capacitive touch apparatus 2f further includes a third touch unit 30. The third touch unit 30 is electrically connected with the first touch unit 21 and the second touch unit 29 in series or in parallel. The third touch unit 30 includes a touch substrate (not shown), a first conductive layer and a second conductive layer. The technical features of the touch substrate, the first conductive layer and the second conductive layer of the third touch unit 30 are the same as those of the touch substrate, the first conductive layer 211 and the second conductive layer 212 of the first touch unit 21, so the detailed descriptions thereof will be omitted. Each of the second touch unit 29 and the third touch unit 30 of this embodiment includes the first conductive layer only, and the sensing electrode of the first conductive layer is rectangular. Two ends of the first conductive layer 211 of the first touch unit 21 are electrically connected with the second touch unit 29 and the third touch unit 30 respectively, and one end of the second conductive layer 212 of the first touch unit 21 is electrically connected with the first selection unit 25 and the second selection unit 28. One end of the second touch unit 29, which is not connected with the first touch unit 21, is electrically connected with the first selection unit 25, and one end of the second touch unit 30, which is not connected with the first touch unit 21, is electrically connected with the second selection unit 28. In other aspects, the end of the second touch unit 29, which is connected with the first touch unit 21, may further electrically connect with the second selection unit 28 (not shown). Similarly, the end of the third touch unit 30, which is connected with the first touch unit 21, may further electrically connect with the first selection unit 25 (not shown).

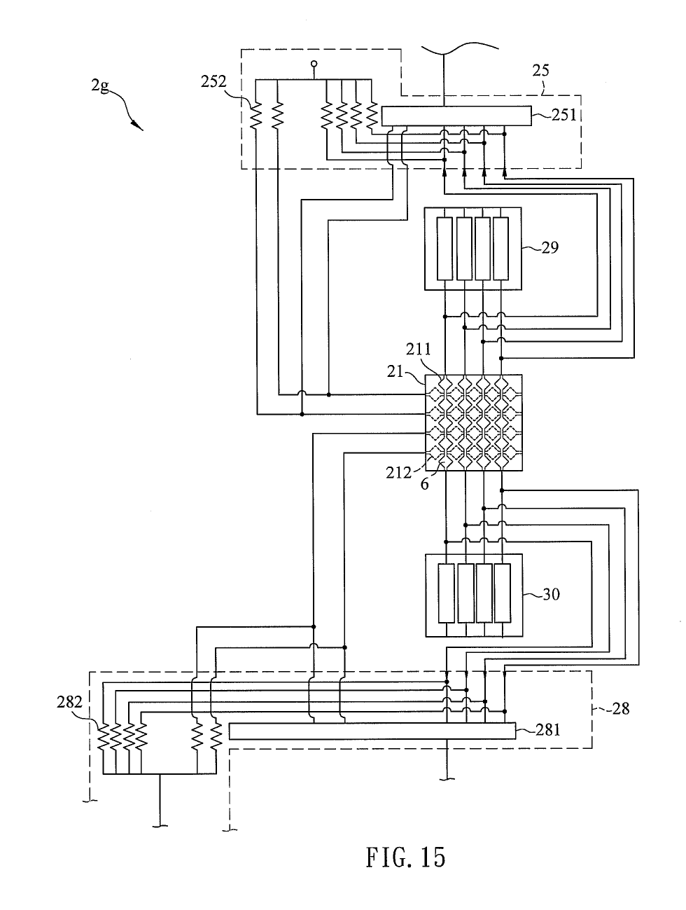

Referring to FIG. 15, the capacitive touch apparatus 2g of this embodiment is different from the capacitive touch apparatus 2f of the previous embodiment in the connections between the first touch unit 21, the second touch unit 29 and the third touch unit 30. In this aspect, two ends of the first conductive layer 211 of the first touch unit 21 are electrically connected with the second touch unit 29 and the third touch unit 30 respectively, and one end of the second conductive layer 212 of the first touch unit 21 is electrically connected with the first selection unit 25 and the second selection unit 28. One end of the second touch unit 29, which is connected with the first touch unit 21, is further electrically connected with the first selection unit 25, and one end of the second touch unit 30, which is connected with the first touch unit 21, is further electrically connected with the second selection unit 28.

In summary, the capacitive touch apparatus of the present invention is configured with a first selection unit with a multiplexer for switching the connections between the first voltage difference retrieving unit and a plurality of sensing conductive bars of the first touch unit. In addition, the first voltage difference retrieving unit includes a first retrieving device and a second retrieving device for respectively retrieving the voltages of two ends of the voltage-drop device so as to determine the touch position and touch time. Furthermore, the capacitive touch apparatus of the present invention further includes a second touch unit, which is electrically connected with the first touch unit, without increasing complex connections and detecting the touch position. Accordingly, the capacitive touch apparatus of the present invention can improve the sensing speed and reduce the manufacturing cost by the simple circuit design.

Although the present invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the present invention.

What is claimed is:

1. A capacitive touch apparatus comprising:
a first touch unit comprising a first conductive layer;
a first voltage difference retrieving unit electrically connected with one end of the first conductive layer and outputting a first voltage signal and a second voltage signal; and
a first feedback signal generating unit electrically connected with the first voltage difference retrieving unit, and outputting a first feedback signal according to the variation of the voltage difference between the first voltage signal and the second voltage signal for computing a touch position.

2. The capacitive touch apparatus according to claim 1, further comprising a control unit electrically connected with the first voltage difference retrieving unit and the first feedback signal generating unit, wherein the control unit receives the first feedback signal for computing the touch position and outputs a power signal to the first voltage difference retrieving unit.

3. The capacitive touch apparatus according to claim 1, wherein the first touch unit comprises a second conductive layer disposed above or below the first conductive layer.

4. The capacitive touch apparatus according to claim 3, wherein the first and second conductive layers respectively comprise a plurality of sensing conductive bars.

5. The capacitive touch apparatus according to claim 4, wherein each of the sensing conductive bars comprises a plurality of sensing electrodes connected in series, and the sensing electrode of each of the sensing conductive bars is rhombic, square, circular or irregular.

6. The capacitive touch apparatus according to claim 5, wherein the sensing conductive bars of the first and second conductive layers are extended in perpendicular and not electrically connected with each other, and one end of the sensing conductive bars of the first and second conductive layers are electrically connected with the first voltage difference retrieving unit.

7. The capacitive touch apparatus according to claim 1, wherein the first voltage difference retrieving unit comprises a first voltage-drop device, a first retrieving device and a second retrieving device, the first voltage-drop device is connected with the first touch unit, a power signal is provided through the first voltage-drop device to the first touch unit, and the first retrieving device connects to one end of the first voltage-drop device and outputs the first voltage signal, and the second retrieving device connects to the other end of the first voltage-drop device and outputs the second voltage signal.

8. The capacitive touch apparatus according to claim 7, wherein each of the first retrieving device and the second retrieving device is a voltage follower.

9. The capacitive touch apparatus according to claim 7, wherein the first feedback signal generating unit comprises an operation device and receives the first voltage signal and the second voltage signal, and the operation device is a differential amplifier.

10. The capacitive touch apparatus according to claim 2, wherein the power signal is a sine-wave power signal.

11. The capacitive touch apparatus according to claim 10, wherein the control unit comprises a microcontroller and a waveform modulator, the microprocessor outputs a square-wave voltage signal to the waveform modulator, and the waveform modulator outputs the sine-wave power signal.

12. The capacitive touch apparatus according to claim 7, further comprising a first selection unit electrically connected with the first touch unit and the first voltage difference retrieving unit.

13. The capacitive touch apparatus according to claim 12, wherein the first selection unit comprises at least one multiplexer and a plurality of resistors, one end of the multiplexer and one end of each of the resistors are electrically connected with the first touch unit, and the other end of the multiplexer is electrically connected with the first voltage difference retrieving unit.

14. The capacitive touch apparatus according to claim 13, wherein the resistance value of the resistor of the first selection unit is much greater than that of the first voltage-drop device.

15. The capacitive touch apparatus according to claim 14, further comprising:
a second voltage difference retrieving unit electrically connected with the other end of the first conductive layer and comprising a second voltage-drop device, a third retrieving device and a fourth retrieving device, wherein the third retrieving device connects to one end of the second voltage-drop device and outputs a third voltage signal, and the fourth retrieving device connects to the other end of the second voltage-drop device and outputs a fourth voltage signal; and
a second feedback signal generating unit comprising an operation device and receiving the third voltage signal and the fourth voltage signal, and outputting a second feedback signal to the control unit according to the voltage difference between the third voltage signal and the fourth voltage signal.

16. The capacitive touch apparatus according to claim 15, further comprising a second touch unit electrically connected with the first touch unit.

17. The capacitive touch apparatus according to claim 16, wherein one end of the second touch unit, which is not connected with the first touch unit, is electrically connected with the first voltage difference retrieving unit.

18. The capacitive touch apparatus according to claim 17, further comprising a third touch unit electrically connected with the first touch unit, and one end of the third touch unit is electrically connected with the second voltage difference retrieving unit.
